(19) United States
(12) Patent Application Publication
(10) Pub. No.: US 2024/0386720 A1
(43) Pub. Date: Nov. 21, 2024

(54) CORRELATING EVENT INFORMATION

(71) Applicant: INTERNATIONAL BUSINESS MACHINES CORPORATION, ARMONK, NY (US)

(72) Inventors: Zachary A. Silverstein, Georgetown, TX (US); Logan Bailey, Atlanta, GA (US); Suman Patra, Kolkata (IN); Jaclyn Rudolf, Bellmore, NY (US)

(21) Appl. No.: 18/317,271

(22) Filed: May 15, 2023

(51) Int. Cl. G06V 20/40; G06Q 50/00

(52) U.S. Cl. CPC G06V 20/44; G06Q 50/01

(57) ABSTRACT

Described are techniques for correlating event information extracted from a social media post to an event captured by an IoT device. The techniques include analyzing a social media post to identify event information to correlate to an event captured by an Internet of Things (IoT) device. The techniques further include identifying an event represented in sensor data generated by an IoT device that correlates to the event information contained in the social media post. The techniques further include generating a notification for an account owner of the social media post to indicate that the event represented in the sensor data generated by the IoT device may be related to the event information in the social media post.

### BACKGROUND

The present disclosure relates to Internet of Things (IoT) networks, and, more specifically, to correlating data generated by IoT devices to events.

Generally, an IoT network integrates a distributed network of “things” into an information technology infrastructure. A “thing” in the IoT network can comprise a device (IoT device) that includes one or more sensors configured to generate data and transmit the data to other nodes in the IoT network. The devices can be distributed over a relatively broad area. For example, devices can be distributed throughout a residential, commercial, and/or regional area to monitor various activities and/or environmental factors within the areas.

### SUMMARY

Aspects of the present disclosure are directed toward a computer-implemented method comprising analyzing a social media post to identify event information to correlate to an event captured by an Internet of Things (IoT) device, where social media account owners provide social media posts to allow correlation of event information in the social media posts to events captured by the IoT devices. The computer-implemented method further comprising identifying an event represented in sensor data generated by an IoT device that correlates to the event information contained in the social media post, where device owners provide sensor data generated by IoT devices to allow the sensor data to be analyzed for events represented in the sensor data, and context information is generated for the events represented in the sensor data to allow correlation of the events to event information contained in the social media posts. The computer-implemented method further comprising generating a notification for an account owner of the social media post to indicate that the event represented in the sensor data generated by the IoT device may be related to the event information in the social media post.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example environment that includes an event correlation service, in accordance with some embodiments of the present disclosure.

FIG. 2 is a flow diagram that illustrates an example method for opting into the event correlation service described in association with FIG. 1.

FIG. 3 is a flow diagram illustrating an example method for correlating event information from a social media post to an event captured by an IoT device, in accordance with some embodiments of the present disclosure.

FIG. 4 is a diagram that illustrates example components of the event correlation service described in association with FIG. 1, in accordance with some embodiments of the present disclosure.

FIG. 5 is a diagram illustrating an example notification that can be sent to an account owner, in accordance with some embodiments of the present disclosure.

FIG. 6 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward correlating event information obtained from a social media post to one or more events captured by one or more IoT devices. While not limited to such applications, embodiments of the present disclosure may be better understood in light of the aforementioned context.

The Internet of things describes devices with sensors, processing ability, software and other technologies that connect and exchange data with other devices and systems over the Internet and/or other communications networks. As these IoT devices have become ubiquitous within residential, business, and public environments, the IoT devices are positioned to capture events happening within these environments. For example, IoT devices capable of capturing images and/or video are commonly placed in areas (e.g., exterior of homes, buildings, outdoor public areas, etc.) to monitor and capture events occurring within the areas. The sensor data (images, video, audio, etc.) generated by these IoT devices contains a wealth of information. However, without context, the sensor data often goes unutilized. For example, a pet without an owner captured in an image by an IoT device attached to an exterior of a residence (e.g., a doorbell camera) may not provide the IoT device owner with a sufficient amount of context information to contact the owner of the lost pet. In fact, unless prompted by an alert that the pet has been lost, the IoT device owner may not review the image feed captured by the IoT device, such that the information captured by the IoT device which could potentially help in returning the pet to the pet owner may never be viewed.

Relatedly, the rise of social media has provided account owners with platforms that can be used to alert other social media users about various events (e.g., lost pets, amber alerts, silver alerts, criminal activity, etc.) that have occurred within a respective neighborhood, town, city, etc. For example, an owner of a social media account can submit a social media post describing an event, which can include an image(s) and/or video related to the event. Referring again to the lost pet example above, the pet owner can post a picture of the lost pet to a social media platform with an indication that the pet is lost. However, the effectiveness of the social media post to locate the lost pet may be limited by the number of people in the neighborhood who view the social media post, and by the number of those people who monitor or check their IoT device image/video feeds. For example, it is unlikely that every person who views the social media post will take the time required to review their IoT device's image/video feed to determine whether the pet was detected by their IoT device.

Advantageously, aspects of the present disclosure overcome the challenges described above by correlating event information extracted from a social media post to one or more events captured by one or more IoT devices. More specifically, social media account owners provide their social media feeds to an event correlation service that analyzes the social media feeds for events and extracts event information that can be correlated to an event captured by an IoT device. Likewise, device owners provide their IoT device feeds to the event correlation service which analyzes the IoT device feeds for events and generates context information for the events that can be correlated to the event information extracted from the social media feeds. More specifically, aspects of the present disclosure analyze a social media post to identify event information to correlate to an event captured in sensor data generated by an IoT device. Aspects of the present disclosure then identify an event represented in the sensor data generated by an IoT device that correlates to the event information in the social media post using context information for the event represented in the sensor data. Aspects of the present disclosure then generate a notification intended for the social media account owner that indicates that the event represented in the sensor data generated by the IoT device correlates to the event information in the social media post.

The aspects of the present disclosure described above provide improvements in the area of event data correlation. More specifically, aspects of the present disclosure address the challenge of determining a relationship between information contained in a social media post and an event captured in sensor data by an IoT device by generating context information for the event that can be matched to the information in the social media post, and providing notice to a user of the relationship. That is, generating context information for an event captured in sensor data in a format capable of being matched to event information extracted from a social media post, and generating a notification for a user when the event captured by the IoT device relates to the social media post, is a technical improvement over existing systems because it allows a user to be notified when an event relating to their social media post is detected by an IoT device. Moreover, the elements of: analyzing social media posts to identify event information, analyzing IoT device generated sensor data for events and generating context information for the events, correlating event information from a social media post to context information for an event captured by an IoT device, and generating a notification for a user to indicate a relationship between the event information from the social media post and the event captured by the IoT device are a practical application that improves over other technologies in the field of event data correlation.

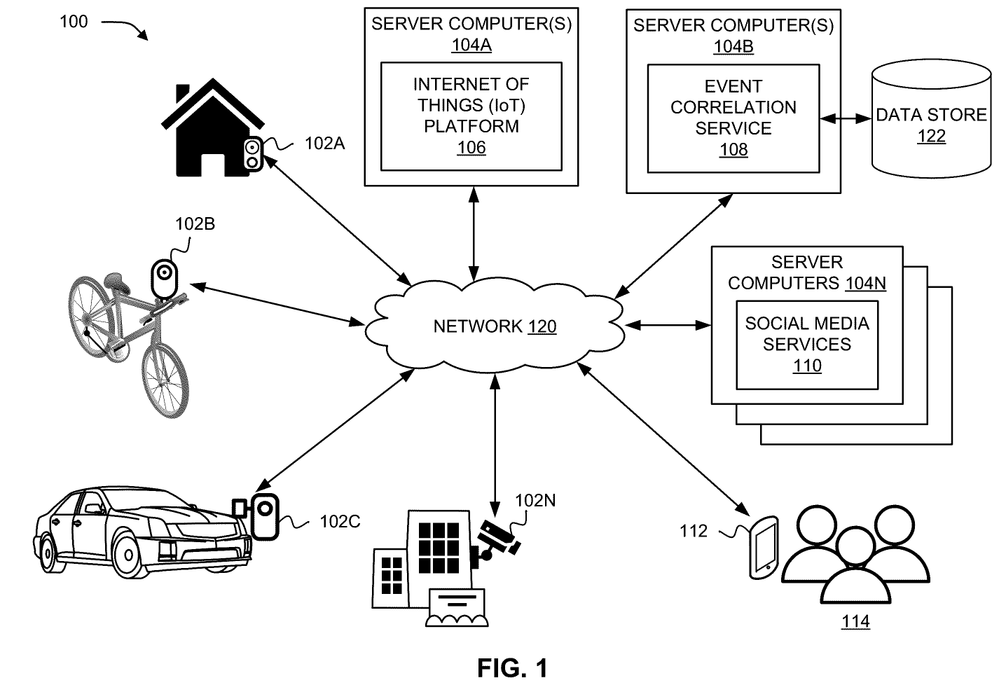

Referring now to the figures, FIG. 1 illustrates a block diagram of an example environment 100 that includes an event correlation service 108, in accordance with some embodiments of the present disclosure. As shown, the example environment 100 includes server computers 104A, 104B, 104N (collectively 104, where N can refer to any positive integer representing any number of server computers) configured to host one or more of the event correlation service 108, an IoT platform 106, and one or more social media services 110. The example environment 100 also includes a plurality of IoT devices 102A, 102B, 102C, 102N (collectively 102, where N can refer to any positive integer representing any number of IoT devices) capable of capturing events represented in sensor data comprising images, videos, audio, and other data in which an event can be captured.

The IoT platform 106 can comprise a suite of components that enable: deployment of applications that monitor, manage, and control the IoT devices 102; remote data collection from the IoT devices 102; and independent and secure connectivity between the IoT devices 102. The suite of components may include, but are not limited to, a hardware architecture, an operating system, a runtime library, one or more edge devices, and/or containerized workloads. The IoT platform 106 manages connections between the IoT devices 102 and the various other applications, services, and/or systems. An IoT device 102 includes sensors (e.g., camera, microphone, accelerometers, thermometers, and other sensors) configured to generate data (e.g., images, video, audio, etc.) capturing aspects of a proximate physical environment, and includes hardware to enable the IoT device 102 to connect to a network 120 and send the data to the IoT platform 106.

A social media service 110 comprises an interactive platform that facilitates the creation and sharing of information, ideas, interests, and other forms of expression through virtual communities and networks. Users 114 of a social media service 110 can access social media services through web-based applications or services that offer social media functionality to the users' mobile devices 112 and/or other types of computing devices. As the users 114 engage with the social media service 110, they create interactive platforms in which individuals, communities, and organizations can share, co-create, discuss, participate, and modify user-generated or self-curated content posted to the social media service 110. Included in the content posted to the social media service 110 are social media posts in which a user 114 describes an event and/or seeks additional information regarding the event.

The event correlation service 108 is configured to correlate event information extracted from a social media post to one or more events captured by one or more IoT devices 102. The event information comprises any type of information that describes and/or references an event capable of being captured by a sensor of an IoT device 102. Social media account owners provide the event correlation service 108 access to their social media content to allow the event correlation service 108 to analyze the social media content for event information and extract the event information from the social media content for correlation to one or more events captured by one or more IoT devices 102. In some embodiments, instead of providing the event correlation service 108 access to a social media feed, a social media account owner can submit (upload) an individual social media post for which they would like the event correlation service 108 to analyze for event information and determine whether an event captured by an IoT device 102 is related to the event information. Optionally, social media account owners can tag their social media post with an event category (e.g., lost pet, missing person, etc.), which the event correlation service 108 can use to identify related events captured by IoT devices 102.

In some embodiments, social media account owners can specify what social media content the event correlation service 108 has access to and how it is used. For example, social media account owners can define participation parameters and privacy parameters. The participation parameters define how a social media account owner participates in the event correlation service 108 (e.g., specifications that limit the use of social media content to certain event categories, geographical regions, times of day, week, month, and/or year, etc.). The privacy parameters indicate what information (e.g., personal identifying information (PII), geographical information, contact information, etc.) the social media account owner is willing to share to the event correlation service 108.

After being provided access to an account owner's social media feed, the event correlation service 108 monitors the social media feed (e.g., based on the account owner's participation and privacy parameters) for social media posts containing event information (e.g., a lost pet, a missing person, a natural event, etc.). In some embodiments, the event correlation service 108 analyzes the text in a social media post using natural language processing to identify event information. Natural language processing (NLP) is a field of computer science, artificial intelligence, and linguistics concerned with the interactions between computers and human (natural) languages. As such, natural language processing is related to the area of human-computer interaction. Many challenges in natural language processing involve natural language understanding, that is, enabling computers to derive meaning from human or natural language input. Components of NLP utilized by the event correlation service can include: part-of-speech tagging (e.g., given a sentence, determine the part of speech for each word in the sentence), named entity recognition (e.g., given a stream of text, determine which items in the text map to proper names, such as people, places, and organizations), terminology extraction (e.g., automatically extract relevant terms from a given corpus), relationship extraction (e.g., given a chunk of text, identify the relationships among named entities, conference resolution (e.g., given a sentence or larger chunk of text, determine which words refer to the same objects, anaphora resolution (e.g., matching up pronouns with the nouns or names to which they refer), topic segmentation and recognition (e.g., given a chunk of text, separate it into segments each of which is devoted to a topic, and identify the topic of the segment), as well as other NLP components.

In cases where a social media post includes one or more images and/or video, the event correlation service 108 analyzes the images and/or video using image recognition to identify an object(s) that may be associated with the event information in the social media post, and the event correlation service 108 generates context information for the object(s) that corresponds to the event information in the social media post. The context information describes attributes of, and/or related to, the object(s). As a non-limiting example, a social media post containing event information related to a lost item can include an image of the item. The event correlation service 108 can extract event information for the lost item from a text description in the social media post using NLP, and the event correlation service 108 can analyze the image using image recognition to identify objects in the image that correspond to the item described in the social media post and generate context information for the item. As a non-limiting example, event information extracted from a social media post may indicate that a bicycle has gone missing and may describe the attributes of the bicycle (e.g., make, model, color, etc.). Based on the event information, the event correlation service 108 can analyze an image included in the social media post to identify an object in the image that resembles the bicycle described in the social media post.

After identifying an object in an image included in a social media post that corresponds to event information in the social media post and generating context information for the object, the event correlation service 108 augments the event information with the context information generated for the object. In some embodiments, the event correlation service 108 only adds the context information for an object to the event information if the event information does not include the context information. As a non-limiting example, event information for an item obtained from a social media post may include a make, style, and color of the item, but not the size of the item. The context information generated for the object in the image can include an estimated size of the item, which can be added to the event information. Similarly, in cases where a social media post includes audio data (e.g., an audio file or video that includes audio), the event correlation service 108 can analyze the audio data to identify a sound that may be associated with the event information in the social media post and generate context information for the sound that can be correlated to audio captured by an IoT device 102.

Owners of IoT devices 102 can provide the event correlation service 108 access to their IoT device feeds (e.g., images, video, audio, and other data) to allow the IoT device feeds to be analyzed for events captured by the IoT devices 102. An event captured by an IoT device 102 is an object in time represented in data (e.g., image, video, audio, etc.) generated by a sensor of the IoT device 102. The object in time can be anything capable of being linked to an event described in a social media post (e.g., a lost pet, a missing person, a natural event, etc.). In some embodiments, instead of providing access to an IoT device feed, an IoT device owner can submit (upload) IoT device generated data (e.g., images, videos, audio, etc.) to the event correlation service 108 to allow the event correlation service 108 to generate context data for an event(s) represented in the data and correlate the context data to event information in a social media post. The IoT device owner can tag the data with an event category (e.g., lost pet, amber alert, silver alert, missing property, etc.) to assist the event correlation service 108 in matching an event represented in the data to event information in a social media post.

In some embodiments, IoT device owners can specify what data in an IoT device feed the event correlation service 108 has access to and how it is used. For example, similar to how social media account owners can define participation parameters and privacy parameters for their social media feeds, IoT device owners can also define participation parameters and privacy parameters for their IoT device feeds. The participation parameters define how an IoT device owner participates in the event correlation service 108 (e.g., specifications that limit the use of IoT device generated data to certain event categories, geographical regions, times of day, week, month, and/or year, etc.). The privacy parameters indicate what information (e.g., personal identifying information (PII), geographical information, contact information, etc.) the IoT device owner is willing to share to the event correlation service 108.

The event correlation service 108 analyzes the content (e.g., images, video, audio, etc.) of an IoT device feed and generates context information for the events represented in the IoT device feed. The event correlation service 108 generates the context information in a format capable of being matched to event information extracted from a social media post (e.g., using standardized terms for data matching). The context information for an event comprises observable attributes of an object in time represented in sensor data (an image, video, and/or audio) generated by an IoT device 102, and can include information related to the conditions and/or environment surrounding the event (e.g., location, time of day, etc.). In some embodiments, the event correlation service 108 stores IoT device feed content with associated context information in a searchable data store 122 to make the content and context information available for searching by the event correlation service 108. The event correlation service 108 can query the searchable data store 122 for context information that corresponds to event information in a social media post. When querying the searchable data store 122, the event correlation service 108 can apply the privacy parameters and participation parameters provided by the individual IoT device owners.

In some embodiments, the event correlation service 108 can send a request to individual IoT device owners asking them for data generated by their IoT device(s) 102 that potentially matches event information in a social media post. Based on the event information, the event correlation service 108 can identify IoT devices 102 that may have captured an event related to the event information, and the event correlation service 108 can send the request to the owners of the IoT devices 102. The request can include the event information from the social media post, which the device owners can use to identify which IoT device generated data to provide. The device owners can then submit (upload) the data determined to be relevant to the event correlation service 108.

In response to identifying one or more events captured by IoT devices 102 that may be related to event information in a social media post, the event correlation service 108 generates a notification to indicate that the one or more events represented in data (e.g., an image, video, audio recording, etc.) generated by IoT device(s) 102 may be related to the event information in the social media post. The event correlation service 108 then sends the notification to a user's device 112 (e.g., a mobile device) associated with the owner of the social media post using, for example, a push protocol, short message service (SMS), multimedia messaging service (MMS), email, or any other appropriate messaging technique. The notification can include any information related to an event represented in sensor data generated by an IoT device 102, including, but not limited to: an image of the event, a location of the event, context information generated by the event correlation service 108, device owner information, as well as other information. Information included in the notification can be limited by the participation and privacy parameters specified by the IoT device owner.

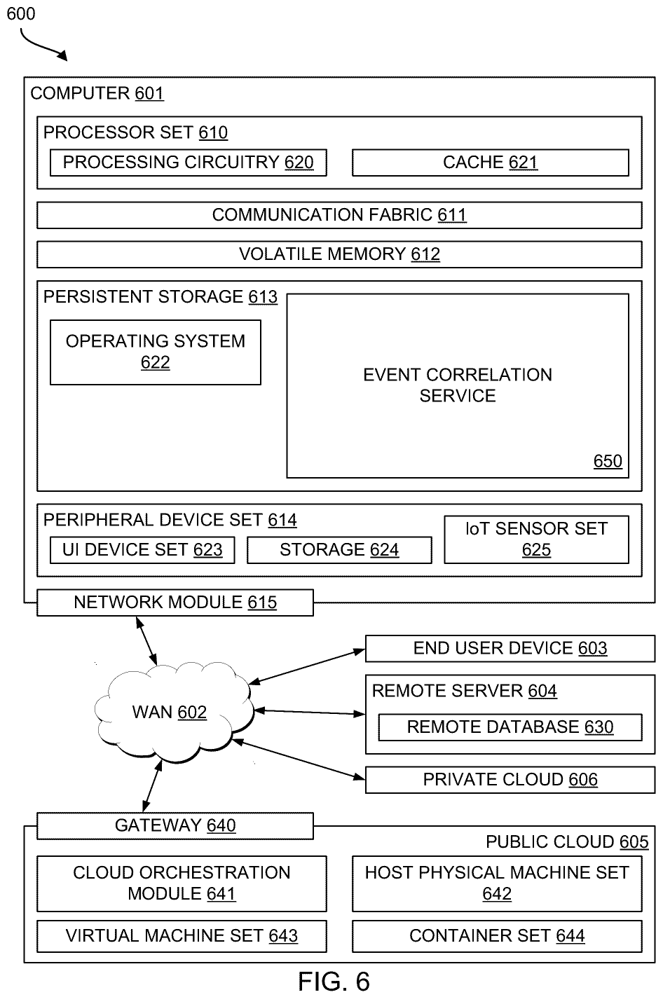

All or a portion of the components shown in FIG. 1 can be implemented, for example by all or a subset of the computing environment 600 of FIG. 6. The event correlation service 108 can be implemented in software, hardware, firmware or a combination thereof. When software is used, the operations performed by the event correlation service 108 can be implemented in program instructions configured to run on hardware, such as a processor unit. When firmware is used, the operations performed by the event correlation service 108 can be implemented in program instructions and data and stored in persistent memory to run on a processor unit. When hardware is employed, the hardware can include circuits that operate to perform the operations of the event correlation service 108.

In some embodiments, the event correlation service 108 can be implemented using software modules hosted in a computing service environment. For example, the software modules can provide a service with one or more processes executing on a server or other computer hardware. Such services can provide a service application that receives requests and provides output to other services or consumer devices. An application programming interface (API) can be provided for each software module to enable a first module to send requests to and receive output from a second module. Such APIs can also allow third parties to interface with the software modules and make requests and receive output from the modules.

In the illustrative example, server computer(s) 104B can be configured to perform at least one of the steps, operations, or actions described in the different illustrative examples using software, hardware, firmware or a combination thereof. As a result, server computer(s) 104B operates as a special purpose computer system in which the event correlation service 108 in server computer(s) 104B enables event correlation among social media posts and IoT device generated sensor data. In particular, the event correlation service 108 transforms server computer(s) 104B into a special purpose computer system as compared to currently available general computer systems that do not have the event correlation service 108.

FIG. 1 illustrates that a network 120 is provided to enable communication between the components illustrated in the example environment 100. The network 120 can include any useful computing network, including an intranet, the Internet, a local area network, a wide area network, a wireless data network, or any other such network or combination thereof. Components utilized for the network 120 can depend at least in part upon the type of network and/or environment selected. Communication over the network 120 can be enabled by wired or wireless connections and combinations thereof.

While FIG. 1 illustrates an example of an environment that can implement the techniques above, many other similar or different environments are possible. The example environments discussed and illustrated above are merely representative and not limiting. Moreover, FIG. 1 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented according to an illustrative embodiment.

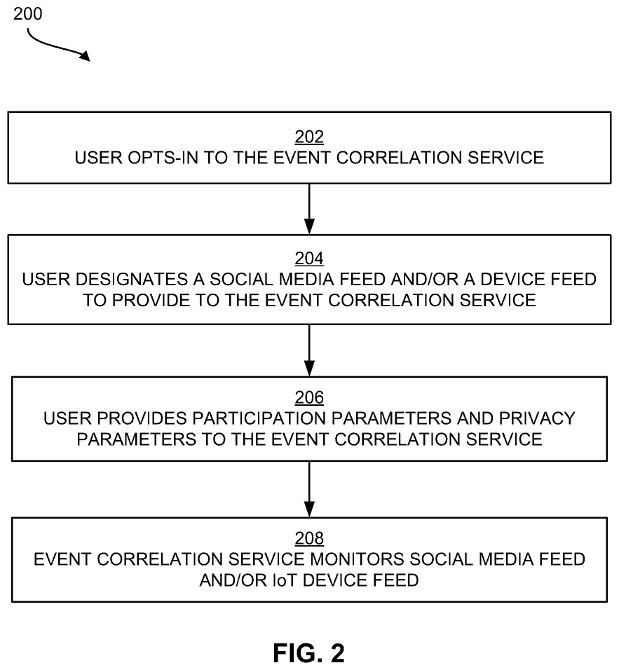

FIG. 2 is a flow diagram illustrating an example method 200 for opting into the event correlation service described in association with FIG. 1. In operation 202, a user opts into the event correlation service by indicating their willingness to provide their social media feed(s) and/or their IoT device feed(s) to the event correlation service.

In operation 204, the user designates the social media feed(s) and/or the IoT device feed(s) to share with the event correlation service. A social media feed comprises a mechanism (e.g., an API) that provides near real-time access to content posted by an account owner to a social media platform. An IoT device feed comprises a mechanism (e.g., an API) that provides near real-time access to sensor data generated by an IoT device. In response to designating a social media feed, the event correlation service can request that the user (i.e., social media account owner) provide the event correlation service access to their social media feed (e.g., via a social media API). Similarly, in response to designating an IoT device feed, the event correlation service can request that the user (i.e., IoT device owner) provide the event correlation service access to their IoT device feed (e.g., via an IoT platform API).

In operation 206, the user provides participation parameters and privacy parameters to the event correlation service. As described earlier, participation parameters define how a user (social media account owner and/or IoT device owner) participates in the event correlation service 108 (e.g., limit to certain event categories, geographical regions, times of day, week, month, and/or year, etc.), and the privacy parameters indicate what information (e.g., personal identifying information (PII), geographical information, contact information, etc.) the user is willing to share to the event correlation service 108. Thereafter, in operation 208, the event correlation service monitors the user's social media feed(s) and/or IoT device feed(s) as described below.

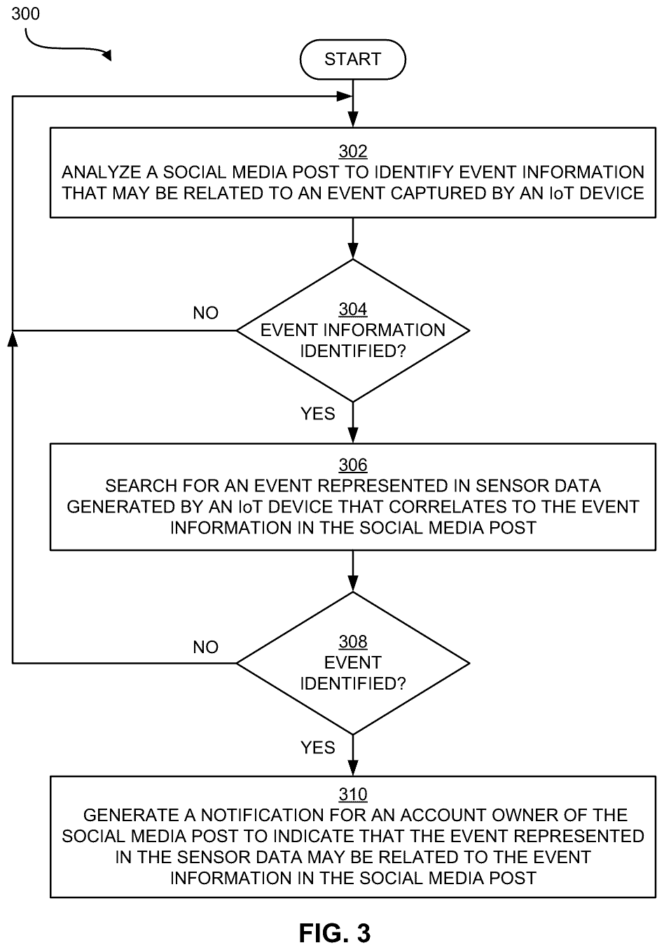

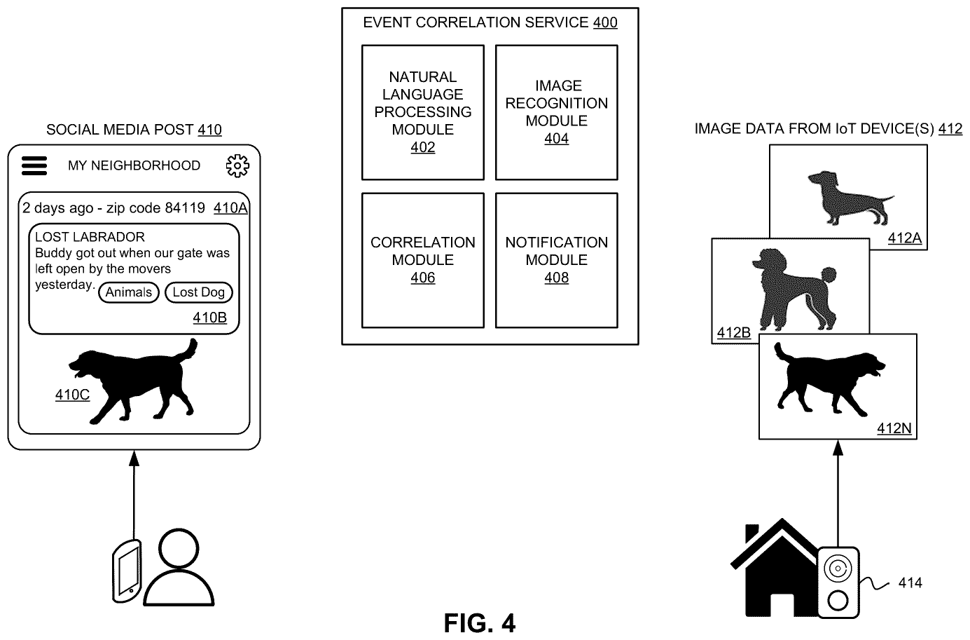

Referring generally to FIG. 3 and FIG. 4, FIG. 3 is a flow diagram illustrating an example method 300 for correlating event information extracted from a social media post to an event captured by an IoT device, and FIG. 4 illustrates example event correlation service components that can be used to perform the method 300. Further, FIG. 4 illustrates an example of a social media post 410 and example IoT device generated images 412A, 412B, 412N (collectively 412, where N can refer to any positive integer representing any number of images generated by one or more IoT devices 414). As will be appreciated, the content of the social media post 410 and the images 412 shown in FIG. 4 are merely representative and are not meant to limit the present disclosure in any way.

As shown, the event correlation service 400 can include a natural language processing module 402, an image recognition module 404, a correlation module 406, and a notification module 408. Starting in operation 302, in response to receiving content posted to a user's social media feed, the method 300 analyzes the content of the social media post 410 to determine whether the content includes event information that can be correlated to an event captured by an IoT device(s) 414.

Analyzing the content of the social media post 410 can comprise analyzing text 410B using NLP to extract/generate event information for an event described in the text 410B. In some embodiments, the natural language processing module 402 analyzes the text 410B using part-of-speech tagging, named entity recognition, terminology extraction, relationship extraction, conference resolution, topic segmentation and recognition, and the like to identify event information in the text 410B that can be matched to context information generated for an IoT device generated image 412. The context information can be descriptive information, such as tags or labels containing keywords and/or terms that can be correlated to other context information generated for an IoT device generated image 412. For example, the text 410B in the social media post 410 can be provided to the natural language processing module 402, which in response analyzes the text 410B to identify words, terms, phrases, relationships, topics, etc. that are associated with an event capable of being represented in an IoT device generated image 412. As a non-limiting example, analysis of the text 410 in the social media post 410 can identify event information that includes “lost dog”, “Labrador”, “Buddy”, “gate left open”, “yesterday”. When analyzed individually or together, the event information may correspond to an event category (e.g., lost pet). Other information in the social media post 410 can also be analyzed to determine whether the information provides additional context. For example, other information 410A, such as a time stamp and a location, can be analyzed by the natural language processing module 402 to determine whether the information 410A adds additional context to the event information identified in the text 410B of the social media post 410.

Also, as shown in FIG. 4, a social media post 410 can include tags (e.g., “Animals”, “Lost Dog”) that provide context for the social media post 410. The event correlation service 400 can include the tags in the event information to assist in identifying an event represented in an image 412 related to the event information.

Also, in the case that a social media post 410 includes an image 410C, the image 410C can be analyzed by an image recognition module 404 to generate context information that corresponds to event information contained in the social media post 410. Image recognition refers to the ability of software (e.g., the image recognition module 404) to identify objects, places, people, writing, and actions in digital images. A computer configured with machine vision technologies in combination with a camera and artificial intelligence (AI) software can perform image recognition and generate context information based on the image recognition. As a non-limiting example, analysis of the image 410C in the social media post 410 by the image recognition module 404 can generate context information that includes: dog breed (e.g., Labrador), dog coat color (e.g., blond), dog eye color (e.g., brown), an approximate dog age (e.g., adult), and other context information. Event information obtained from the text 410B of the social media post 410 can be augmented with the context information generated for the image 410C.

In some embodiments, the event correlation service 400 can determine what context information generated for an image 410C included in a social media post 410 corresponds to event information contained in the text 410B of the social media post 410 and augment the event information with context information that corresponds to the event information. For example, when event information in a social media post 410 relates to a lost dog, context information (e.g., dog characteristics) that corresponds to a lost dog event can be added to the event information, and other context information generated for the image 410C that does not relate to a lost dog event (e.g., a person who happens to be included in the image) may not be included in the event information.

In operation 304, in the case that event information is identified in the social media post 410, then in operation 306, the method 300 searches for an event represented in sensor data (e.g., an image 412) generated by an IoT device 414 that correlates to the event information contained in the social media post 410. As described earlier, IoT device owners provide their sensor data feeds to the event correlation service 400, and the image recognition module 404 processes images included in the sensor data to generate context information for events represented in the images. In some embodiments, the sensor data and context information can be stored in a searchable data store (not shown) to make the sensor data available for searching by the correlation module 406.

In some embodiments, the correlation module 406 searches for an image 412 in an IoT device feed using the event information from the social media post 410. That is, the correlation module 406 searches for context information associated with an image 412 that matches the event information from the social media post 410. As a non-limiting example, event information for a lost pet can include pet characteristics (e.g., dog breed, coat color, eye color, etc.), a location where the pet was last seen, and other information that can be matched to context information generated for an image 412 in an IoT device feed. When searching for an image 412 that corresponds to the event information in a social media post 410, the correlation module 406 can apply privacy parameters and participation parameters specified by the IoT device owners, as described earlier. Also, in some embodiments, determining that an event represented in an image 412 matches event information in a social media post 410 can be based on a percentage match. The percentage can be calculated as a percentage of event information in a social media post 410 that matches context information for an image 412 in an IoT device feed. If the percentage is above a match threshold (e.g., 50%, 55%, 70%, etc.), then the event represented in the image 412 can be considered as being related to the event information in the social media post 410.

Also, in some embodiments, a geographic region associated with a social media post 410 (e.g., a city, town, neighborhood, etc.) can be used to identify a subset of images generated by IoT devices 414 located within the geographic region, and context information for the subset of images can be searched to identify one or more images in the subset that correspond to event information in the social media post 410. Also, in some embodiments, based on a type or category of event described in a social media post 410, the correlation module 406 can determine a geographic boundary or perimeter within which to search for IoT device generated images 412 that may have captured an event related to the event described in the social media post 410. As an example, in the case of a lost pet, the correlation module 406 can define a geographic boundary that corresponds to an amount of time since the pet was reported lost and physical characteristics of the lost pet (e.g., size, age, weight, health, etc.) that may determine how far the pet is able to travel from the point of origin where the pet was lost. The correlation module 406 can then identify a subset of images associated with one or more IoT devices 414 located within the geographic boundary to determine whether the lost pet was captured in an image generated by any of the IoT devices 414.

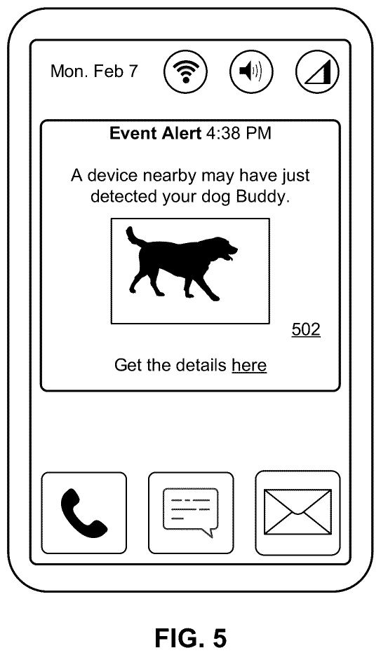

In operation 308, if an event represented in an image 412 generated by an IoT device 414 is identified as being related to the event information in the social media post 410, then in operation 310, the notification module 408 generates a notification for an account owner of the social media post 410 to indicate that the event represented in the image 412 may be related to the event information in the social media post 410. With continued reference to FIG. 3 and FIG. 4, the example notification 502 illustrated in FIG. 5 can be sent to a social media account owner when an image 412 is identified as being related to event information in the social media post 410. The notification 502 can reference the social media post 410 and include event details for the event captured in the image 412 based on the privacy parameters and participation parameters specified by an IoT device owner.

The method 300 illustrated in FIG. 3 can be performed by a computer (e.g., computer 601 in FIG. 6), performed in a cloud environment (e.g., clouds 606 or 605 in FIG. 6), and/or generally can be implemented in fixed-functionality hardware, configurable logic, logic instructions, etc., or any combination thereof. In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the disclosed methods, such as block 650 that contains computer code for the event correlation service described earlier. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 621 and the other storage media discussed below. The computer readable program instructions, and associated data, are accessed by processor set 610 to control and direct performance of the disclosed methods. In computing environment 600, at least some of the instructions for performing the disclosed methods may be stored in block 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 650 typically includes at least some of the computer code involved in performing the disclosed methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. It is also to be understood that the terms “approximately” or “substantially” as used herein with regard to percentages, ranges, temperatures, times and other process parameters, etc., are meant to denote being close or approximate to, but not exactly. For example, the term “approximately” or “substantially” as used herein implies that a small margin of error is present, e.g., ±0.2%, ±0.5%, ±1%, etc.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
analyzing a social media post to identify event information to correlate to an event captured by an Internet of Things (IoT) device, wherein social media account owners provide social media posts to allow correlation of event information in the social media posts to events captured by IoT devices;
identifying an event represented in sensor data generated by an IoT device that correlates to the event information contained in the social media post, wherein device owners provide sensor data generated by IoT devices to allow the sensor data to be analyzed for events represented in the sensor data, and context information is generated for the events represented in the sensor data to allow correlation of the events to event information contained in the social media posts; and
generating a notification for an account owner of the social media post to indicate that the event represented in the sensor data generated by the IoT device may be related to the event information in the social media post.

2. The computer-implemented method of claim 1, wherein analyzing the social media post further comprises:
analyzing text in the social media post using natural language processing (NLP) to generate the event information.

3. The computer-implemented method of claim 1, wherein analyzing the social media post further comprises:
analyzing one or more images contained in the social media post to generate context information that corresponds to the event information in the social media post; and
augmenting the event information from the social media post with the context information generated from the one or more images.

4. The computer-implemented method of claim 1, further comprising, in response to receiving sensor data generated by an IoT device:
processing the sensor data to generate context information for the event represented in the sensor data; and
storing the sensor data with the context information in a data store to make the sensor data searchable via the context information.

5. The computer-implemented method of claim 4, wherein identifying the event represented in the sensor data generated by the IoT device further comprises:
querying the data store for context information linked to sensor data that corresponds to the event information from the social media post.

6. The computer-implemented method of claim 5, wherein querying the data store further comprises applying privacy parameters and participation parameters specified by the device owners.

7. The computer-implemented method of claim 1, further comprising sending a request to the device owners for sensor data that matches the event information.

8. The computer-implemented method of claim 1, further comprising:
determining a geographic region associated with the event based in part on a location associated with the social media post and a boundary associated with an event category; and
identifying a subset of sensor data provided by the device owners that correspond to the geographic region.

9. The computer-implemented method of claim 1, wherein the sensor data from the IoT device is user-submitted sensor data uploaded to an event correlation service.

10. The computer-implemented method of claim 1, wherein the social media post is a user-submitted social media post tagged with an event category and uploaded to an event correlation service.

11. A system comprising:
one or more computer readable storage media storing program instructions and one or more processors which, in response to executing the program instructions, are configured to:
analyze a social media post to identify event information to correlate to an event captured by an Internet of Things (IoT) device, wherein social media account owners provide social media posts to allow correlation of event information in the social media posts to events captured by IoT devices;
identify an event represented in sensor data generated by an IoT device that correlates to the event information contained in the social media post, wherein device owners provide sensor data generated by IoT devices to allow the sensor data to be analyzed for events represented in the sensor data, and context information is generated for the events represented in the sensor data to allow correlation of the events to event information contained in the social media posts; and
generate a notification for an account owner of the social media post to indicate that the event represented in the sensor data generated by the IoT device may be related to the event information in the social media post.

12. The system of claim 11, wherein the program instructions configured to cause the one or more processors to analyze the social media post are further configured to cause the one or more processors to:
analyze one or more images contained in the social media post to generate context information that corresponds to the event information in the social media post; and
augment the event information from the social media post with the context information generated from the one or more images.

13. The system of claim 11, wherein the program instructions are further configured to cause the one or more processors to:
in response to receiving sensor data from an IoT device, process the sensor data to generate context information for the event represented in the sensor data; and
store the sensor data with the context information in a data store to make the sensor data searchable via the context information.

14. The system of claim 13, wherein the program instructions configured to cause the one or more processors to identify the event represented in the sensor data generated by the IoT device are further configured to cause the one or more processors to:
query the data store for context information linked to the sensor data that corresponds to the event information from the social media post.

15. The system of claim 14, wherein the program instructions configured to cause the one or more processors to query the data store are further configured to cause the one or more processors to:
apply privacy parameters and participation parameters specified by the device owners to the query.

16. A computer program product comprising:
one or more computer readable storage media, and program instructions collectively stored on the one or more computer readable storage media, the program instructions configured to cause one or more processors to:
analyze a social media post to identify event information to correlate to an event captured by an Internet of Things (IoT) device, wherein social media account owners provide social media posts to allow correlation of event information in the social media posts to events captured by IoT devices;
identify an event represented in sensor data generated by an IoT device that correlates to the event information contained in the social media post, wherein device owners provide sensor data generated by IoT devices to allow the sensor data to be analyzed for events represented in the sensor data, and context information is generated for the events represented in the sensor data to allow correlation of the events to event information contained in the social media posts; and
generate a notification for an account owner of the social media post to indicate that the event represented in the sensor data generated by the IoT device may be related to the event information in the social media post.

17. The computer program product of claim 16, wherein the program instructions configured to cause the one or more processors to analyze the social media post are further configured to cause the one or more processors to:
analyze one or more images contained in the social media post to generate context information that corresponds to the event information in the social media post; and
augment the event information from the social media post with the context information generated from the one or more images.

18. The computer program product of claim 16, wherein the program instructions are further configured to cause the one or more processors to:
in response to receiving sensor data generated by an IoT device, process the sensor data to generate context information for the event represented in the sensor data; and
store the sensor data with the context information in a data store to make the sensor data searchable via the context information.

19. The computer program product of claim 18, wherein the program instructions configured to cause the one or more processors to identify the event represented in the sensor data generated by the IoT device are further configured to cause the one or more processors to:
query the data store for context information linked to sensor data that corresponds to the event information from the social media post.

20. The computer program product of claim 19, wherein the program instructions configured to cause the one or more processors to query the data store are further configured to cause the one or more processors to:
apply privacy parameters and participation parameters specified by the device owners to the query.
